(19) United States
(12) Patent Application Publication
(10) Pub. No.: US 2003/0091812 A1
(43) Pub. Date: May 15, 2003

(54) Breathable, flexible wax release coating on a construction underlayment

(75) Inventor: Boris Zubry, Princeton, NJ (US)

Correspondence Address: GAF MATERIALS CORPORATION, Att: William J. Davis, Esq., Legal Department, Auilding No. 10, 1361 Alps Road, Wayne, NJ, 07470, US

(73) Assignee: BUILDING MATERIALS INVESTMENT CORPORATION

(21) Appl. No.: 10/010,618

(22) Filed: Nov. 13, 2001

(51) Int. Cl. B32B 5/16

(52) U.S. Cl. 428/323; 428/497; 428/327

(57) ABSTRACT

This invention relates to an asphaltic roofing underlayment having a flexible layer of a polypropylene wax deposited in discrete droplets on its surface to provide a flexible release coating and to allow venting of gaseous material from said underlayment.

### BACKGROUND OF THE INVENTION

Several problems associated with release coatings of polyethylene and/or polypropylene currently applied to tacky surfaces of construction materials have been the subject of recent research. Primarily, the current non-porous films and sheets of polymer applied to tacky surfaces of asphaltic based materials is prone to rupture due to air and light end asphalt exudents which are entrapped during instalation. This tendency is particularly pronounced during torching and often leads to injury of roofers. Minimization of this problem has required expensive, substantially thick polymer coatings and inefficient use of polymer. Also, the thicker coatings increase the rigidity of the asphaltic material so that care must be taken to avoid bending during handling. Accordingly, many manufacturers and consumers prefer inorganic release agents such as particulate limestone, sand, talc and the like. However, these particles are easily rushed off, leaving random areas of adhesion between layers of the asphaltic membrane. Separation of layers in these unprotected areas often causes damage to the membrane itself.

Accordingly, it is an object of this invention to minimize or eliminate the above disadvantages associated with release coatings.

More specifically, it is an object of the invention to provide a hazard free release coating which is stable at high temperatures and which can be applied to a substrate by an economical and commercially feasible process.

Still another object is to provide a porous substrate coating free of rupture sites resulting from entrapped gas pockets.

Still another object is to provide a porous substrate coating free of rupture sites resulting from entrapped gas pockets.

Still another object is to provide a more flexible release coating which minimizes the amount of polymer needed to accomplish desired release coating results.

These and other objects and benefits of the invention will become apparent from the following description and disclosure.

### SUMMARY OF THE INVENTION

This invention concerns an asphaltic underlayment membrane or shingle having a tacky surface uniformly covered with droplets of a propylene wax polymer as a surface layer.

### DETAILED DESCRIPTION OF THE INVENTION

In accordance with this invention there is provided a breathable release coating of amorphous propylene wax having a softening point of below about 170° F., preferably between about 60° and about 100° F., a density of from abut 0.8 to about 0.92 at 25° C. and a Maximum Hardness Penetration of from about 0.8 to about 9.5 dmm. The wax is applied to the asphaltic substrate in a thickness of from a unimolecular layer to about 3.5 mils by a spraying or misting discrete liquid droplets to provide a flexible, porous coating which allows venting of air and light end exudates from the substrate. The droplets are allowed to drop freely from the sprayer under the influence of gravity from a distance above the substrate such that they retain their spherical shape and do not spread to form a continuous impervious film on the substrate surface. The droplets are in the form of microspheres which are gelled at a temperature sufficient to withstand deformation upon impact with the asphaltic substrate and to provide a coating having a multipored, gas pervious surface. The coating guards against adherence of tacky asphaltic surfaces during packaging, storage and shipment and is not brushed or blown off as in the case of powdery release agents which can leave exposed tacky areas adhering together. Optionally, the present porous coating can be removed before installation of the roofing or siding underlayment material.

The wax employed for the present coating can be obtained in liquid or solid form. However, in the later case, the wax must be melted or dissolved in a suitable organic solvent so that the spray application can be effected. Suitable organic solvents for solid polypropylene wax include toluene, benzene, carbon tetrachloride, chloroform, cyclohexane, turpentine, petroleum ether, anisole and the like. Solutions of up to 75% solvent are useful for spray applications when the source is a solid wax; however it is preferable to avoid the use of solvent and instead to melt the solid wax to a sprayable condition.

Optionally, the polypropylene wax can contain a minor amount of comonomer modifiers as a secondary wax such as ethylene bis-stearamide wax polymer, polyethylene wax and the like, preferably at a concentration not in excess of about 10 wt. %; although the unmodified propylene homopolymer is preferred.

Generally, the liquid wax or solid wax dissolved in solvent can be sprayed on the substrate at ambient temperature; whereas the undissolved solid wax requires a temperature at least above its melting point, eg. 170-260° F., preferably a temperature at least 5° above its melting point, before applying to the substrate surface.

Extraneous additives, such as a desiccant, an antioxidant, etc. can be included in the wax spray composition and, when employed, are present at a concentration not exceeding 5 wt. % of the total composition.

Having generally described the invention, reference is had to the following example which illustrate preferred embodiments and comparison with an underlayment coated with a current polypropylene film.

### COMPARATIVE EXAMPLE

Two samples, A and B, of standard BUR roofing base sheets (RUBEROID®) are coated with a 2 mil layer of release coating. The surface of Sample A is sprayed at about 70° F. with microspheres of polypropylene wax having a density of about 0.85 at 25° C., a Maximum Hardness Penetration of about 8.5 dmm and a softening point of about 65° F.; whereas the surface of Sample B was coated to the same thickness with a continuous film of polypropylene resin using the doctor blade of a coating apparatus. After drying, sample A has a smooth, glossy surface appearance; whereas after drying, the surface of Sample B is uneven and rougher due to entrapped air bubbles. Upon bending the coated substrate 15°, Sample A exhibits no fracture; whereas 6% fracture is evidenced in Sample B.

What is claimed is:

1. A bitumen roofing underlayment having at least one surface uniformly coated with a release coating consisting essentially of discrete droplets of an amorphous polymeric hydrocarbon wax containing 90-100% polypropylene wax and having a softening point of from about 75-170° F. to provide the underlayment surface with a porous, breathable, flexible surface.

2. The underlayment of claim 1 wherein the polypropylene wax is modified with up to 10% of a secondary wax of polyethylene and/or bis-stearamide wax polymer.

3. The underlayment of claim 1 wherein said wax is 100% polypropylene.

4. The underlayment of one of claims 1, 2 or 3 wherein said wax has a softening point of between about 60° and about 100° F.

5. The composition comprising a tacky asphaltic sheet material of construction having at least one tacky surface coated with discrete droplets of an unmodified amorphous propylene wax polymer or the amorphous propylene wax polymer modified with up to 10% of a second wax of polyethylene and/or bis-stearamide polymer in a layer thickness of from a unimolecular layer up to a 3.5 mils wax polymer layer to provide a flexible, porous and releasable surface on said sheet.

6. The composition of claim 5 wherein said droplets are composed of 100% polypropylene.

7. The composition of claim 5 wherein said sheet material is rolled and used in BUR roofing.

8. The composition of claim 5 wherein said sheet material is cut and used as roofing shingles.

9. The process of preparing the underlayment of claim 1 which comprises applying to a tacky surface of an asphaltic sheet, discrete microspheric droplets of an amorphous hydrocarbon wax polymer of propylene having a softening point below 170° F. by spraying the wax at a controlled distance above said sheet such that the wax droplets retain their spherical shape and prevent their spreading into a continuous, gas impervious film.

10. The process of claim 9 wherein said amorphous hydrocarbon wax polymer of propylene is 100% polypropylene.

11. The process of claim 9 wherein said amorphous hydrocarbon wax polymer is a mixture of polypropylene up to 10% modified with a secondary wax polymer of polyethylene and/or bis-stearamide wax polymer.

12. The process of claim 9 wherein said amorphous hydrocarbon wax polymer of propylene has a softening point of between about 60° and about 100° F. and wherein spraying is effected at a temperature at least 5° above the softening point of the wax.

13. The process of claim 9 wherein said wax is a solid and is premelted to a spraying condition before applying to said sheet.

14. The process of claim 9 wherein said wax is a solid and is pre-dissolved in a sufficient amount of an organic solvent to provide a sprayable liquid solution before applying to said sheet.

15. The process of claim 9 wherein said wax is a liquid.
